(19) United States
(12) Patent Application Publication
(10) Pub. No.: US 2003/0087700 A1
(43) Pub. Date: May 8, 2003

(54) Variant E-mail service for creating amusement between users

(76) Inventor: Tsung-Hsing Wei, Taipei (TW)

Correspondence Address: STEVENS, DAVIS, MILLER & MOSHER, L.L.P., Suite 850, 1615 L Street, N.W., Washington, DC, 20036, US

(21) Appl. No.: 09/985,830

(22) Filed: Nov. 6, 2001

(51) Int. Cl. A63F 13/00

(52) U.S. Cl. 463/42

(57) ABSTRACT

The variant E-mail service is to combine three different common services (e-mail service, role playing game, matchmaking service) together as whole service on Internet to build variant E-mail service in cyber space with the function of “virtual friendship making” like playing with software game to provide an amusing service between users with fun and entertainment.

First step, the new variant e-mail service of this invention has to request those users to fictitiously set up the background information to the role that he/she wants to be playing. He/she also registers the all features of an idealized dream lover that he/she wishes to make friend with.

And then, a couple in cyber space of variant E-mail service were picked and matched according to their set up roles. A couple will be introduced with all he/she set up background information to his/her dream lover in cyber space of variant E-mail service.

Third step, the couple matched playing the role they set and can make friend with each other by variant E-mail service. Both of them are talking about their very personal inner feeling, inner passion to each other, making a very romantic friendship outside their real life. The romantic friendship will be abounding of interesting and amusement effect to users of variant E-mail service. This is a very attractive reconstructed new e-mail service.

### BACKGROUND OF THE INVENTION

1. Field of the Invention

The present invention is related to a method of building variant E-mail service in cyber space with entertainment effect, and more particularly to a method of making users playing with E-mail in cyber space capably enjoy amusement and excitation derived from variant E-mail service of this present invention.

2. Description of the Related Art

As is known to all, Electronic Mail (E-mail) Service on Internet, Role Playing Game (RPG) Service to play a role of character in a software game with fun, and Matchmaking Service to match friend couple by computer, are three different common services to people now. Usually, not only does every individual service (E-mail, RPG or Matchmaking) have their own particular users group separately, but also said three different common services were never combined together as a whole service before. Their users have definite purpose to use one of the services separately. Said three different common services are separately described as follows:

(a) Electronic Mail (E-Mail) on Internet

E-mail service is the most popular service used on Internet. Many Internet companies provide free e-mail service to attract more visitors and better click rate. You can easily find a tremendous amount of free e-mail service providers by searching through Yahoo. You can find and register many free e-mail accounts everywhere. The e-mail account is almost a kind of free resource on Internet. Most of e-mail account provided is only a box to issue and receive e-mail letters, or a place to communicate with others.

The anonymity is the most important character for a user of common e-mail service. Everybody has his nickname while his navigating on Internet. For the reason of privacy, the e-mail provider will not expose the user's personal information. An e-mail account name or a nickname to any other person is only an account. Therefore, nobody knows where he/she is, and who he/she is.

(b) Role Playing Game (RPG)

Role playing games (RPG) are the most selling games in the market. A role playing game was designed and based on a story. There are a definite number of roles in the story. The some one particular role's konfu level, strength, strategic level, weapon, magic power, life period, and face, dress etc. are all designed in the program. All the possible ways of interaction between two roles are also designed in program.

A player get into the game, just only need choose a designed role to play and use his smart finger and quick reaction. The player will never involve to design and set up the feature of any role in program.

No matter single user game or multi-user game, the party whom you had ever fought down is just the program, not a real person.

(c) Matchmaking Service

The personal information must be true is a basic requirement in a matchmaking service. Computer taken as a matchmaker to introduce matching friend couple is vigorously developed recently. Normally, matchmaking members must type into his/her real detail person and family background information along with the features of the person with whom he/she wishes to make friend.

After searching and matching by matchmaking program, a couple of most suitable were selected by computer operation. Those two matched persons will be introduced to each other. They will meet and date, and, if possible, they will go to marriage finally.

### SUMMARY OF THE INVENTION

In the normal circumstance, it is impossible to combine three prior common services (E-mail, RPG and Matchmaking) together as a whole service in practice or in logic. The only way to combine said three common services is that you must reconstruct said three common services simultaneously by the method described in this present invention.

Anonymity and hiding truth are the typical property of the Internet. Many people don't like this property very much. They all want to eliminate the bad effect of anonymous and false matter to minimum.

On the contrary, for the reason of fun and amusement, we have expanded this property to the maximum and applied to the new variant E-mail service of this invention. This is just opposite common experience of confidence. The new variant e-mail service of this present invention has to request those users to fictitiously set up the background information for the role that he/she wants to be playing. Thus, the variant E-mail service of this invention may combine three different common services (E-mail, RPG and Matchmaking) by a method of re-construction to an opposite direction of common experience.

The variant E-mail service of this present invention, attached with the interaction of Role Playing Game & Matchmaking, becomes a place not only to issue/receive e-mail, but also provide a place of virtual friend making between lover couple matched. Said service is the source of user's everyday amusement to create and transmit additional amusement to all users. The amusement effect increased the mail service's additional value. Resulted in a common free e-mail service on Internet will have economic value produced and will bring in the revenue from the customers.

One aspect of this invention is to build variant E-mail service in cyber space with the function of “virtual friendship making in cyber space or pseudo-world” just like in a software game to provide an amusing service between users to have fun and entertainment. It will satisfy human being's desire of seeking exciting, curiosity, and chasing additional romantic friendship outside of marriage.

Another aspect of this invention is that all requirements of person's detail and family background information originally as an entry record of computer must be always prior claimed as unreal or fictitious information. So that those users of variant E-mail service of this invention can arbitrarily self-perform or self-vary one's favorite character played in a cyber space with fun.

Further aspect of this invention is to make users capably be acted as an idealized person to match a very eagerly idealized pseudo-correspondent as pseudo-lover in cyber space of E-mail environment. So that those idealized pseudo-lovers can talk of everything under the sun, and even have an intimate talk in cyber space also, to condole their spirits each other and derive fun and entertainment from variant E-mail service of this invention.

### BRIEF DESCRIPTION OF THE DRAWINGS

The invention will be better understood by reference to the following drawings when reading the description of the invention contained herein:

FIG. 1 is a flow chart of this invention of variant service for E-mail to create amusement between users.

### DETAILED DESCRITION OF THE PREFERRED EMBODIMENTS

The features and advantages of this invention are described in this specification in conjunction with the drawings illustrating a preferred embodiment of the invention.

This invention is a variant E-mail service for creating amusement between users by building a cyber space on common E-mail environment like playing a software game to have fun and entertainment between users of E-mail. In other words, how to convert real world of E-mail environment into cyber space like software games with entertainment is disclosed by this invention.

The variant E-mail service of this invention can combine prior three different common services (E-mail service, RPG service and Matchmaking service) together on Internet, but every said prior common service must be distorted or re-constructed as opposite common experience of confidence by the method of this invention. So that this kind of variant E-mail service of this invention may then provide a cyber space or pseudo-world to make virtual romantic friendship with fun, exciting and amusement.

Here below explain how to provide a variant E-mail service of this invention through said three prior basic services re-construction:

1. Re-Constructed E-Mail

Many crimes are covered by anonymity on Internet. Some anonymous e-mail users may cheat others by hiding truth or making false. For the reason of fun, the variant E-mail service of this invention takes the anonymity to the surface and expands anonymity to the maximum. Those users of variant E-mail service of this invention to set up or trump up a new and fictitious personal background in advance must be requested. Every user must be hidden behind of “new person” set up by himself/herself.

Before playing, all personal background information set up must express clearly to his/her matched e-mail friend. In the surface, every e-mail account's background information is opened to his/her friend matched. So that it makes this account be so realized and so embodied.

In the other hand, we also clearly announce that all information about his/her friend matched are factitious and not real, and are set up.

Although the above two opposite and contrary concepts are conflicting violently, the conflict could then make a great fun and amusement between users.

The variant E-mail service of this invention requests users to set up or trump up his/her background story and open to the other person, and this are both opposite to the way of all common e-mail service providers have done.

2. Re-Constructed Role Playing

In the common type of Role Playing Games, the roles in games are designed and set up by programmer. All individual role's function, konfu level, magic power grade, weapons, life period, treasures, face or dress are absolutely designed by programmer. The player can only set up very few variables by himself. The most important input to the game is smart finger strength, and better memory for try and error. The players are only playing with computer program.

The variant E-mail service of this invention is established on “factitious personal background set up”. All new users of variant E-mail service of this invention must be requested to set up his/her new role's personal features. According to very detail optional chart designed on this present invention to set up “new person” factitious information including new name, new birthday, star, birth place, school graduated, family member, real estate, bank deposits, career occupation, marriage, height, weight, interest, habit, specialized skill, what like, same-sex-idol, opposite-sex-idol, and all features of his/her dream lover that he/she want to make friend with.

The boy user may set up himself as a role of handsome and young gentleman. The girl user may set up herself as a role of beautiful and well-educated young lady.

A couple matched can write to each other about his/her very inner heart by e-mail love letter. What have an exciting experience you gotten! How much the fun and amusement you may get! What an attractive service do we provide?

The role playing we provided have the following properties:

(a) All background information of every role was directly set up by user, and not by programmer. The role to be interacted with is another user, but not program.

(b) The e-mail output in between a couple roles will be differently varied from couple to couple. You will never get a same story from other couples. It of course will create many different results far from a programmed game due to mail content created by user of variant E-mail service of this invention.

(c) Under the variant E-mail service of this invention, there are many role players and many friend players, but not game players.

3. Re-Constructed Matchmaking

In the normal type of marriage matchmaking service, the couple matched must be meeting and dating, and, if possible, go to marriage finally. The variant E-mail service of this invention must ask users to set up or fictionalize a new role feature that he/she wants to play. No matter how many portions or what portion of his/her information set up are true, we all think that as false.

For the reason of preventing the virtual friendship between couple roles comes true, the meeting of users are prohibited. This is an important property of this invention.

The method to prohibit meeting between users is to re-create users' face image file. We combine the user's picture and his/her same-sex-idol's picture as a synthesized pseudo-photograph by image process program. The new picture we made is the new face which near user's real face and also very near the face of his/her idol. So this is a perfect new face representing the role he/she wants to play.

The new face as well as all information he/she set up will be introduced to a matched friend near his/her dream lover. The new face has the functions of:

(a) At the beginning period, the perfect face will attract the both hearts of the couple matched tightly.

(b) The user's new face is so handsome or so beautiful. It naturally prevents the meeting between user couple outside Internet with his/her real face. The function of preventing meeting between user couple will do not harm to user's real life and real family.

Accordingly mentioned above, one key of this invention to build a cyber space or pseudo-world on E-mail environment like software game is invented to reverse all matter-of-fact requirements from all user's background information to user's real face image. Because those pseudo-requirements are wholly set up as fictitious, false or unreal information, then every e-mail account's background information must be opened to his/her friend matched to build a cyber space not necessarily kept as secret as matched couple before. So that it makes E-mail account be much more realized and embodied.

Another key of this invention is ruled the users of variant E-mail service who are fully forbidden from meeting each other in real world for the reason of being continuously kept as a couple of idealized lovers or pseudo-correspondents in cyber space. Any people or user of this present invention may correspond with the other specially designated user as idealized lover or pseudo-correspondent in a created cyber space or pseudo-world on E-mail environment capably executed as a friendship playing with fun in cyber space on E-mail environment each other.

Therefore, member user of variant E-mail service of this invention may conceal his/her identity and arbitrarily change his/her identity at any time even to pretend himself/herself as the most idealized people whom he/she is eager to be in real world. He/she can imaginably consider himself or herself as an outstanding or casual and elegant people with charming appearance such as a gentleman or a noble lady in high society, famous movie star, sportsman or sportswoman, a charming politician or statesman, or a sexy lover in dream. For enjoyment, user of this invention can arbitrarily decide how to play role of the other character who is existed in real world or created in pseudo-world to enjoy fun on E-mail environment rather than in a software game. In other words, user of this invention can perform any new person whom said user wants to be just as a character programmed in a cyber space of software game but created on common E-mail environment. A couple of idealized lovers or pseudo-correspondents matched by this invention can write to each other about his/her very inner heart by e-mail love letter and can talk of everything under the sun by E-mail in cyber space to enjoy every much exciting, fun and entertainment each other.

Further key of this invention is to re-create users' face image to increase enjoyment. In combination of user's same-sex-idol and user's own appearance a composite pseudo-photograph is synthesized as an idealized handsome gentleman or beautiful lady shown as new face for the a user of variant E-mail service of this invention. This synthesized pseudo-photograph must be opened and known to idealized lovers or pseudo-correspondents each other in cyber space matched by variant E-mail service of this invention. Said idealized lovers or pseudo-correspondents will have an exquisite memory with fun by E-mail in cyber space created on E-mail environment.

By this way, this invention is completed to build a cyber space or pseudo-world on E-mail environment like software game with fun. By the incoming and outgoing of E-mail with epistolary correspondence, user of variant E-mail service of this invention may issue or receive unreal but exciting or exaggerate messages full of amusement in cyber space to satisfy said users' curiosity and desires and further to release their nervous spirits. Every user couple cooperate to create particular story like in a special novel, they enjoy novel romance by himself/herself.

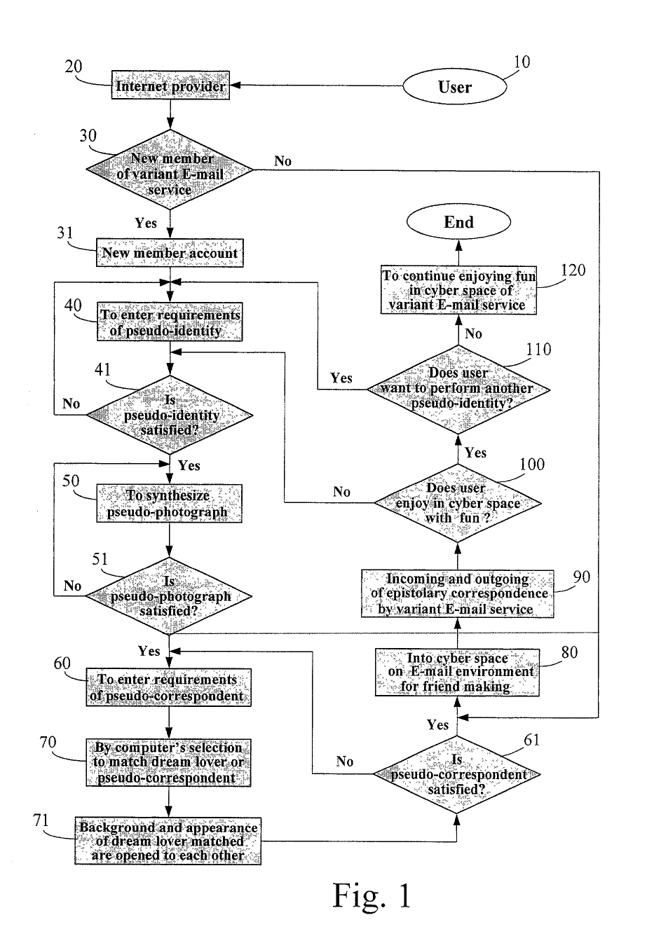

A preferred embodiment of this invention is shown in FIG. 1. This invention of “variant E-mail service” is in advance claimed as a game playing in cyber space but more exciting and fun then prior role playing software games. All user of “variant E-mail service” must make an entry of fictitious or unreal information as record of computer. Therefore, a boy or a man can set up himself as a handsome gentleman come from a famous powerful family, and a girl or a woman also may set up herself as a very beautiful and well-educated lady. And all users of E-mail service of this invention are ruled out as absolutely forbidden from meeting and dating each other in real world.

A new user of this invention must set up or trump up a particular new personal background (a role) that he/she wants to play. He/she also must register the all features of a dream lover with whom he/she wishes to make friend. And then, a couple was picked and matched according to their set up roles. A couple will be introduced each other with all his/her set up background information to his/her dream lover. The couple of users playing the role they set, making friend with each other by variant E-mail service of this invention. With this variant E-mail service of this invention, both of them are talking about their very personal inner feeling, inner passion to each other, making a very romantic friendship outside their real life. The romantic friendship is abounding of interesting or amusement effect.

Further referring to FIG. 1 the method of this invention of “variant service for E-mail” is described as follows comprising steps of:

An user 10 who like to navigate Internet once intentionally or inadvertently visits an Internet provider 20 in which a “variant E-mail service” of this invention is provided and a statement as mentioned on above two paragraphs has announced. At step 30 to check whether said user 10 is a new member user of “variant E-mail service” or not, if the said user 10 who is a member of “variant E-mail service” may go directly to step 80 of “into cyber space on E-mail environment for friend making”, and read a love letter from matched dream lover, or compose a lover letter to dream lover; and if said user 10 is a new visitor and wants to play or joint said variant E-mail service, he/she should register a membership to get a new member account on step 31.

A new user, at step 40 “to enter requirements of pseudo-identity”, keys in fictitious information as an entry record of computer, so that said user 10 can conceal and change oneself original identity to arbitrarily perform anyone to whom said user 10 want to be; namely, said user 10 can for oneself imaginably decide which pseudo-character is to be played as a role of “variant E-mail service” of this invention; thus, said user 10 can purposely performs to be an outstanding, casual, or elegant people with charming appearance or to be a user's same-sex-idol or opposite-sex-idol existed in real world but just created in cyber space of “variant E-mail service”; if a pseudo-identity imaginably played in cyber space or pseudo-world is not satisfied to said user 10, at step 41 of “whether pseudo-identity is satisfied or not?”, said user 10 can go back to step 40 to reenter requirements setting of pseudo-identity again until to be satisfied to said user 10; after set up a pseudo-identity to be imaginably played in pseudo-world, said user 10 still has to synthesize a pseudo-photograph at step 50, said pseudo-photograph is synthesized as a handsome gentleman or beautiful lady by combination of user's same-sex-idol photograph and user's own photograph and shown on “variant E-mail service” of this invention; if a pseudo-photograph is not satisfied to said user 10, at step 51 of “whether pseudo-photograph is satisfied or not”, said user 10 can go back to step 50 to synthesize other new pseudo-photograph again until to be satisfied to said user 10; after then, said user 10 further goes to step 60 to enter what conditions of a dream lover or a pseudo-correspondent in cyber space who are vigorously wished to make friend. At step 70 of “by computer's selection to match dream lover or pseudo-correspondent”, a most suitable couple was selected and matched. Both of them are the dream lovers for each other. And at step 71, all backgrounds and appearances of dream lovers or pseudo-correspondents matched are opened to each other on the “variant E-mail service” of this invention, so that said user 10 can directly look said pseudo-lover's appearance from pseudo-photograph and know background of said dream lover. If said dream lover or pseudo-correspondent in cyber space selected in step 60 is not satisfied as a dream lover to said user 10, when go to step 61 of “whether said pseudo-correspondent is satisfied or not”, said user 10 can go back to step 60 to change and enter new requirements of pseudo-correspondent again until the most idealized pseudo-lover is selected in step 60 to be satisfied to said user 10; otherwise, in step 80, said user 10 is informed of a E-mail address of very eagerly idealized pseudo-lover or pseudo-correspondent of said user 10 and go into cyber space of this invention to enjoy fun as playing software game, by way of incoming and outgoing of epistolary correspondence between said user 10 and said idealized pseudo-lover in step 90, the couple matched can talk of everything under the sun, chat about all sorts of subjects, talk about their very personal inner feeling and inner passion to each other, have an intimate talk and talk love in cyber space, and make a very romantic friendship outside their real life, so that both of them can condole their spirits and derive fun, excitation and entertainment from issuing or receiving pseudo-love-messages between couple under “variant E-mail service” of this invention wherein; if said user 10 in step 90 is gradually not feeling to enjoy fun or excitation from an idealized pseudo-lover selected in cyber space, when into step 100 of “whether said user 10 enjoys to said pseudo-lover with fun or not in cyber space”, said user 10 can go back to step 41 to confirm whether this pseudo-identity now played or performed as a role in cyber space by said user 10 is satisfied or not, if not, said user 10 can further go back to step 40 to reenter other favorite requirements of pseudo-identity again until to be more satisfied to said user 10, then to repeat the steps of this invention to vary any one of conditions to have more exciting and amusing under service of “variant E-mail service” of this invention; in step 110, while said user 10 is still with fun in step 100 but wants to pursue more exciting or amusing under variant E-mail service of this invention, if yes, said user 10 can further go back to step 40 to change requirements of pseudo-identity again, then to repeat the steps of this invention to enjoy fun, excitation and amusing more and more under variant E-mail service of this invention; if not, at step 120, said user 10 is to continue enjoying exciting and fun in cyber space of variant E-mail service with said idealized dream lover or pseudo-correspondents, and to relax his/her pressure of living.

What I claimed is:

1. A variant E-mail service for creating amusement between users, which is to build a cyber space on E-mail environment like in a software game, comprising steps of:
registering as a new member to get a member account, if user of variant E-mail service is a new user;
entering requirements of pseudo-identity of said user, as an entry record of computer wherein said user should conceal or change one's original identity to purposely perform any pseudo-character to whom said user wants to be in cyber space or pseudo-world, and enter pseudo-requirements of background;
synthesizing a pseudo-photograph as said user's new appearance, which photograph is synthesized as an idealized human being in cyber space in combination of said user's same-sex-idol or opposite-sex-idol photograph and said user's own original photograph, and which new photograph must be shown and opened on variant E-mail service;
entering requirements of pseudo-identity of an idealized dream lover or a pseudo-correspondent to be matched, as an entry record of computer to enter what conditions of an idealized dream lover or a pseudo-correspondent in cyber space vigorously wished to make friend;
matching a dream lover or a pseudo-correspondent by computer's selection, wherein said dream lover or pseudo-correspondent selected almost near to an idealized dream lover of said user;
making pseudo-backgrounds and pseudo-appearances be known to between dream lovers, whose backgrounds and appearances are shown and known to said user and said idealized dream lover or pseudo-correspondent to build a cyber space of variant E-mail service more tangible and concrete as under real world;
starting on variant E-mail service for friend making in cyber space, whose E-mail address of said idealized dream lover or pseudo-correspondent is informed of to said user, and if said user is a registered user, he/she may directly go to this step into cyber space for friend making;
incoming and outgoing of epistolary correspondence in cyber space by variant E-mail service, wherein both of said user and said idealized lover matched can talk of everything under the sun, chat about all sorts of subjects, have an intimate talk or talk love in pseudo-world each other then to condole their spirits and derive fun and excitation from receiving or issuing pseudo-love-messages; and
continuing enjoying fun in cyber space of variant E-mail service, wherein said user can enjoy an exquisite memory with fun and excitation in cyber space due to said user forbidden from meeting said idealized lover or pseudo-correspondent in real world but in cyber space on variant E-mail service.

2. the variant E-mail service of claim 1, further comprising:
determining pseudo-identity imaginably played by said user whether satisfied, wherein said user can go back to step of entering requirements of pseudo-identity again, if not satisfied, to renew requirements of pseudo-identity in cyber space until to be satisfied to said user.

3. the variant E-mail service of claim 1, further comprising:
determining pseudo-photograph synthesized whether satisfied, wherein said user can go back to step of synthesizing a pseudo-photograph as said user's photograph again, if not satisfied, to renewably synthesize idealized pseudo-photograph of said pseudo-identity in cyber space until satisfied.

4. the variant E-mail service of claim 1, further comprising:
determining idealized dream lover or pseudo-correspondent matched by computer's selection whether satisfied, wherein said user can go back to step of entering requirements of pseudo-identity of an idealized dream lover or a pseudo-correspondent to be matched again, if not satisfied, to reenter new requirements of pseudo-correspondent in cyber space until satisfied.

5. the variant E-mail service of claim 2, further comprising:
determining whether enjoying fun from cyber space of variant E-mail service, wherein said user can go back to step of determining pseudo-identity imaginably played by said user whether satisfied again, if not enjoying fun, to reenter new requirements of pseudo-identity in cyber space until further satisfied.

6. the variant E-mail service of claim 1, further comprising:
determining whether wished to re-perform new pseudo-identity, wherein said user can go back to step of entering requirements of pseudo-identity of said user again to enjoy more fun and exciting from cyber space of variant E-mail service.

7. the variant E-mail service of claim 5, further comprising:
determining whether wished to re-perform new pseudo-identity, wherein said user can go back to step of entering requirements of pseudo-identity of said user again to enjoy more fun and exciting from cyber space of variant E-mail service.

8. the variant E-mail service of claim 7, further comprising:
determining idealized dream lover or pseudo-correspondent matched by computer's selection whether satisfied, wherein said user can go back to step of entering requirements of pseudo-identity of idealized dream lover or pseudo-correspondent to be matched again, if not satisfied, to reenter new requirements of pseudo-correspondent in cyber space until satisfied.
